(19) United States
(12) Patent Application Publication
(10) Pub. No.: US 2025/0086936 A1
(43) Pub. Date: Mar. 13, 2025

(54) IMAGE AND VIDEO CLASSIFICATION

(71) Applicant: SAMSUNG ELECTRONICS CO., LTD, Suwon-si (KR)

(72) Inventors: Salar HOSSEINI KHORASGANI, Toronto (CA); Zhiming HU, Vaughan (CA); Iqbal Ismail MOHAMED, Markham (CA); Weiming REN, Waterloo (CA)

(73) Assignee: SAMSUNG ELECTRONICS CO., LTD, Suwon-si (KR)

(21) Appl. No.: 18/670,139

(22) Filed: May 21, 2024

Related U.S. Application Data
(60) Provisional application No. 63/537,162, filed on Sep. 7, 2023.

(51) Int. Cl. G06V 10/764; G06T 7/11

(52) U.S. Cl. CPC G06V 10/764; G06T 7/11

(57) ABSTRACT

Provided are system, method, and device for determining a classification of an image. According to embodiments, the method may include: determining, by a patch sampler model, selection probabilities of a first plurality of patches included in an image; selecting, by the patch sampler model, a second plurality of patches from among the first plurality of patches of the image based on the selection probabilities; and determining a classification of the image by processing the second plurality of patches through an encoder; wherein the patch sampler model may be trained based on a sampling loss which indicates a difference between the selection probabilities and attention scores of the image obtained via the encoder.

### CROSS REFERENCE TO RELATED APPLICATIONS

This application claims priority from U.S. Provisional Patent Application No. 63/537,162, filed with the United States Patent and Trademark Office on Sep. 7, 2023, the disclosure of which is incorporated herein by reference in its entirety.

### TECHNICAL FIELD

Systems, methods, and computer programs consistent with example embodiments of the present disclosure relate to image and video classification.

### BACKGROUND

Vision Transformers (ViTs) have attracted growing attention for their potential to be applied in various applications, such as image and video classifications. A ViT-based model refers to a process to classify an image (or a video) by dividing the image (or a video) into a plurality of patches and feeding the plurality of patches into a ViT encoder.

In this regard, ViTs often face the computational challenges which stems from the quadratic complexity of self-attention with respect to the number of input patches. The computational resource requirements (complexity) may be considered as n², where n here represents the number of input patches to be processed by the ViT encoder. In other words, the higher number of patches used as an input, the higher computational resources are required to perform the classification.

In typical ViTs, they take all patches as inputs during inference. However, not all patches are equally important and some images may have a large number of unimportant patches, which may unnecessarily waste computational resources (since the ViTs consider all patches as input), leading to sub-optimal performance and inefficiency.

In the related art, solutions have been proposed to select and process only a number of patches in order to reduce the computational resource requirements. One solution involves selecting distinctive patches using the K-Center search algorithm, which reduces redundancy in the input patches. Another solution involves training a differentiable policy network with an original classification model in order to select important input patches.

Nevertheless, the above solutions may have at least the following shortcomings.

While the solution to select distinctive patches using the K-Center search algorithm can reduce redundancy in the input patches, not all distinctive patches are important or informative. Further, while the solution to train a differentiable policy network with an original classification model can select important input patches, such solution involves relying on weak supervision of a single class label per image. As such, while the above solutions can reduce the number of patches to be processed, the selected patches may not be important, informative, and/or representative of the image resulting in sub-optimal performance.

Accordingly, there is a need for a system that can reduce computational resources usage, while also being able to achieve good performance and accurate determination of a classification of the image.

### SUMMARY

Example embodiments of the present disclosure may dynamically perform classification of image and/or video, while filtering out uninformative patches to improve performance.

According to embodiments, an image processing method is provided. The method may include: determining, by a patch sampler model, selection probabilities of a first plurality of patches included in an image; selecting, by the patch sampler model, a second plurality of patches from among the first plurality of patches of the image based on the selection probabilities; and determining a classification of the image by processing the second plurality of patches through an encoder; wherein the patch sampler model may be trained based on a sampling loss which indicates a difference between the selection probabilities and attention scores of the image obtained via the encoder.

According to embodiments, the attention scores may be computed based on attention weights of the second plurality of patches, and each of the attention weights may indicate an importance of a corresponding patch of the second plurality of patches.

According to embodiments, each of the attention scores may be computed by: for a specific patch among the second plurality of patches, computing a plurality of individual attention scores from a plurality of transformer layers of the encoder; and aggregating the plurality of individual attention scores to obtain the attention score for the specific patch.

According to embodiments, the plurality of transformer layers may include a last n layers of the encoder, where n may be a natural number between 1 and a total number of transformer blocks in the encoder, and the computing the plurality of individual attention scores may include: computing n individual attention scores from the last n layers of the encoder; and summing the n individual attention scores to obtain the attention score for the specific patch.

According to embodiments, the plurality of individual attention scores may be computed according to a following equation:

$${R}_{attn j}^{( i )} = \frac{1}{K} {\sum }_{k = 1}^{K} {A}_{k , j}^{( i )} \times ‖ {V}_{j}^{( i )} ‖ ,$$

where R_{attn j}⁽ⁱ⁾ may represent an attention score of patch j from transformer layer i, K may represent a number of selected patches, A_{k,j}⁽ⁱ⁾ may represent an attention weight between patch k and patch j from transformer layer i, and Vⱼ⁽ⁱ⁾ may represent a value matrices of patch j from transformer layer i.

According to embodiments, the determining the selection probabilities may include: determining the selection probabilities of the first plurality of patches; determining attention scores of the second plurality of patches; calculating the sampling loss based on the selection probabilities of the second plurality of patches and the attention scores of the second plurality of patches; updating the selection probabilities of the first plurality of patches based on the sampling loss; and repeating the determining the selection probabilities, the determining the attention scores, the calculating the sampling loss, and the updating the selection probabilities until the sampling loss between a distribution of the selection probabilities of the second plurality of patches and a distribution of attention scores of the second plurality of patches is reduced to a predetermined threshold or converges.

According to embodiments, the patch sampler model may be trained using a reinforce algorithm based on the selection probabilities as an action and the attention scores as a reward.

According to embodiments, the patch sampler model may be trained using a Mean Squared Error (MSE) loss or a Kullback-Leibler (KL) Divergence loss.

According to embodiments, the encoder may be trained based on a cross entropy loss.

According to embodiments, an image processing system is provided. The system may include: a memory storage storing computer-executable instructions; and at least one processor communicatively coupled to the memory storage, wherein the at least one processor may be configured to execute the instructions to: determine, by a patch sampler model, selection probabilities of a first plurality of patches included in an image; select, by the patch sampler model, a second plurality of patches from among the first plurality of patches of the image based on the selection probabilities; and determine a classification of the image by processing the second plurality of patches through an encoder; where the patch sampler model may be trained based on a sampling loss which indicates a difference between the selection probabilities and attention scores of the image obtained via the encoder.

According to embodiments, the attention scores may be computed based on attention weights of the second plurality of patches, and each of the attention weights may indicate an importance of a corresponding patch of the second plurality of patches.

According to embodiments, each of the attention scores may be computed by: for a specific patch among the second plurality of patches, computing a plurality of individual attention scores from a plurality of transformer layers of the encoder; and aggregating the plurality of individual attention scores to obtain the attention score for the specific patch.

According to embodiments, the plurality of transformer layers may include a last n layers of the encoder, where n may be a natural number between 1 and a total number of transformer blocks in the encoder; and the plurality of individual attention scores may be computed by: computing n individual attention scores from the last n layers of the encoder; and summing the n individual attention scores to obtain the attention score for the specific patch.

According to embodiments, the plurality of individual attention scores may be computed according to a following equation:

$${R}_{attn j}^{( i )} = \frac{1}{K} {\sum }_{k = 1}^{K} {A}_{k , j}^{( i )} \times ‖ {V}_{j}^{( i )} ‖ ,$$

where R_{attn j}⁽ⁱ⁾ may represent an attention score of patch j from transformer layer i, K may represent a number of selected patches, A_{k,k}⁽ⁱ⁾ may represent an attention weight between patch k and patch j from transformer layer i, and Vⱼ⁽ⁱ⁾ may represent a value matrices of patch j from transformer layer i.

According to embodiments, the at least one processor may be configured to execute the instructions to determine the selection probabilities by: determining the selection probabilities of the first plurality of patches; determining attention scores of the second plurality of patches; calculating the sampling loss based on the selection probabilities of the second plurality of patches and the attention scores of the second plurality of patches; updating the selection probabilities of the first plurality of patches based on the sampling loss; and repeating the determining the selection probabilities, the determining the attention scores, the calculating the sampling loss, and the updating the selection probabilities until the sampling loss between a distribution of the selection probabilities of the second plurality of patches and a distribution of attention scores of the second plurality of patches is reduced to a predetermined threshold or converges.

According to embodiments, the patch sampler model may be trained using a reinforce algorithm based on the selection probabilities as an action and the attention scores as a reward.

According to embodiments, the patch sampler model may be trained using a Mean Squared Error (MSE) loss or a Kullback-Leibler (KL) Divergence loss.

According to embodiments, the encoder may be trained based on a cross entropy loss.

According to embodiments, a non-transitory computer-readable recording medium is provided. The non-transitory computer-readable recording medium may have recorded thereon instructions executable by at least one processor of a system to cause the at least one processor to perform a method including: determining, by a patch sampler model, selection probabilities of a first plurality of patches included in an image; selecting, by the patch sampler model, a second plurality of patches from among the first plurality of patches of the image based on the selection probabilities; and determining a classification of the image by processing the second plurality of patches through an encoder; wherein the patch sampler model may be trained based on a sampling loss which indicates a difference between the selection probabilities and attention scores of the image obtained via the encoder.

According to embodiments, the attention scores may be computed based on attention weights of the second plurality of patches, and each of the attention weights may indicate an importance of a corresponding patch of the second plurality of patches.

Additional aspects will be set forth in part in the description that follows and, in part, will be apparent from the description, or may be realized by practice of the presented embodiments of the disclosure.

### BRIEF DESCRIPTION OF THE DRAWINGS

Features, advantages, and significance of exemplary embodiments of the disclosure will be described below with reference to the accompanying drawings, in which like signs denote like elements, and wherein:

FIG. 1 illustrates a block diagram of example components in a Classification Determining (CD) system, according to one or more embodiments;

FIG. 2 illustrates a block diagram of example components in a Classification Determining (CD) system, according to one or more embodiments;

FIG. 3 illustrates an example plurality of patches comprised in an image;

FIG. 4 illustrates an example flow for determining a classification of an image, according to one or more embodiments;

FIG. 5 illustrates a flow diagram of an example method for determining a classification of an image, according to one or more embodiments; and

FIG. 6 illustrates a flow diagram of an example method for determining the selection probabilities, according to one or more embodiments.

### DETAILED DESCRIPTION

The following detailed description of example embodiments refers to the accompanying drawings. The same reference numbers in different drawings may identify the same or similar elements.

The foregoing disclosure provides illustration and description but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, in the descriptions of operations provided below, it is understood that one or more operations may be omitted, one or more operations may be added, one or more operations may be performed simultaneously (at least in part), and the order of one or more operations may be switched.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code. It is understood that software and hardware may be designed to implement the systems and/or methods based on the description herein.

Even though particular combinations of features are disclosed in the specification, these combinations are not intended to limit the disclosure of possible implementations. In fact, many of these features may be combined in ways not specifically disclosed in the specification.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]” or “at least one of [A] or [B]” are to be understood as including only A, only B, or both A and B.

It is contemplated that features, advantages, and significances of example embodiments described hereinabove are merely a portion of the present disclosure, and are not intended to be exhaustive or to limit the scope of the present disclosure.

Further descriptions of the features, components, configuration, operations, and implementations of the threshold tuning system of the present disclosure, according to one or more embodiments, are provided in the following.

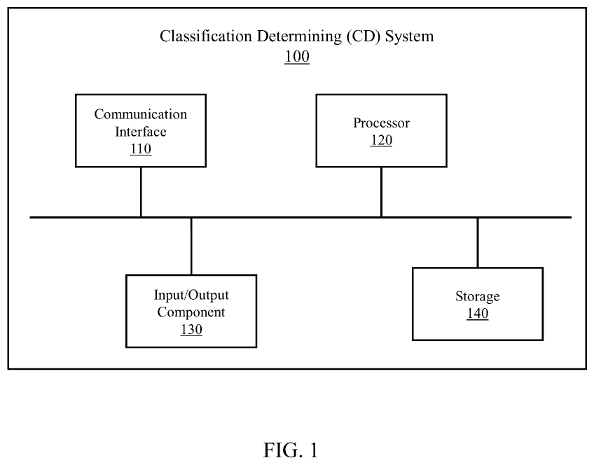

FIG. 1 illustrates a block diagram of example components in a Classification Determining (CD) system 100, according to one or more embodiments.

The CD system may include a system, a platform, a module, or the like, which may be configured to perform one or more operations or actions for determining a classification. According to embodiments, the CD system 100 may be, or may be included in, a device. For example, the CD system 100 may be included in a mobile device such as a smart phone, a television (TV), tablet, a smart vacuum cleaner, augmented reality glasses, virtual reality glasses, a smart refrigerator, and the like.

As illustrated in FIG. 1, the CD system 100 may include at least one communication interface 110, at least one processor 120, at least one input/output component 130, and at least one storage 140, although it can be understood that the CD system 100 may include more or less components than as illustrated in FIG. 1, and/or the components may be arranged in a manner different from FIG. 1, without departing from the scope of the present disclosure.

The communication interface 110 may include at least one transceiver-like component (e.g., a transceiver, a separate receiver and transmitter, a bus, etc.) that enables the components of the CD system 100 to communicate with each other and/or to communicate with one or more components external to the CD system 100, such as via a wired connection, a wireless connection, or a combination of wired and wireless connections.

For example, the communication interface 110 may couple the processor 120 to the storage 140 to thereby enable them to communicate and to interoperate with each other in performing one or more operations. As another example, communication interface 110 may couple the CD system 100 (or one or more components included therein), so as to enable them to communicate and to interoperate with each other.

According to one or more embodiments, the communication interface 110 may include one or more application programming interfaces (APIs) which allow the CD system 100 (or one or more components included therein) to communicate with one or more software applications.

The input/output component 130 may include at least one component that permits the CD system 100 to receive information and/or to provide output information. It can be understood that, in some embodiments, the input/output component 130 may include at least one input component (e.g., a touch screen display, a button, a switch, a microphone, a sensor, etc.) and at least one output component (e.g., a display, a speaker, one or more light-emitting diodes (LEDs), etc.), each of which may be separated from each other.

The storage 140 may include one or more storage mediums suitable for storing data, information, and/or computer-executable instructions therein. According to embodiments, the storage 140 may include at least one memory storage, such as a random access memory (RAM), a read only memory (ROM), and/or another type of dynamic or static storage device (e.g., a flash memory, a magnetic memory, and/or an optical memory) that stores information and/or instructions for use by the processor 120. Additionally or alternatively, the storage 140 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

According to embodiments, the storage 140 may be configured to store information, such as raw data, metadata, or the like. Additionally, or alternatively, the storage 140 may be configured to store one or more information associated with one or more operations performed by the processor 120. For example, the storage 140 may store information defining the historical operation(s) performed by the processor 120 to determine a classification, one or more results of operations performed by the processor 120, or the like. Further, the storage 140 may store data or information required in determining a classification.

In some implementations, the storage 140 may include a plurality of storage mediums, and the storage 140 may be configured to store a duplicate or a copy of at least a portion of the information in the plurality of storage mediums, for providing redundancy and for backing-up the information or the associated data. Furthermore, the storage 140 may also store computer-readable or computer-executable instructions which, when being executed by one or more processors (e.g., processor 120), causes the one or more processors to perform one or more actions/operations described herein.

The processor 120 may include at least one processor capable of being programmed or being configured to perform a function(s) or an operation(s) described herein. For example, the processor 120 may be configured to execute computer-executable instructions stored in at least one storage medium or a memory storage (e.g., storage 140, etc.) to thereby perform one or more actions or one or more operations described herein.

According to embodiments, the processor 120 may be configured to receive (e.g., via the communication interface 110, via the input/output component 130, etc.) one or more signals and/or one or more user inputs defining one or more instructions for performing one or more operations. Further, the processor 120 may be implemented in hardware, firmware, or a combination of hardware and software. For example, processor 120 may include at least one of a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), and/or another type of processing or computing component.

According to embodiments, the processor 120 may be configured to collect, to extract, and/or to receive one or more information (in the form of signal or data, etc.), and to process the received one or more information to thereby determine a classification.

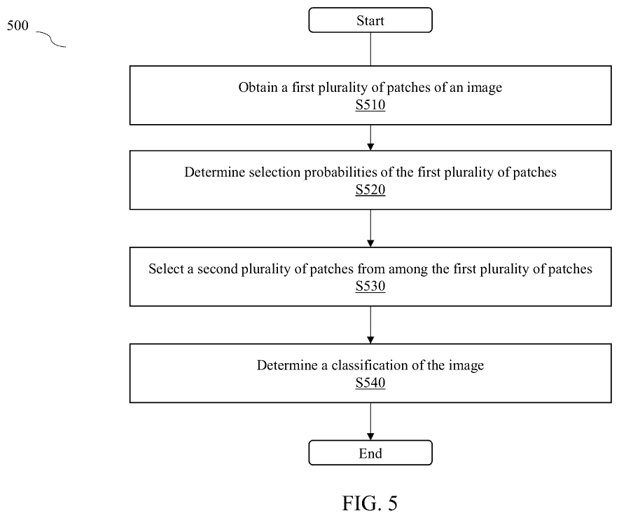

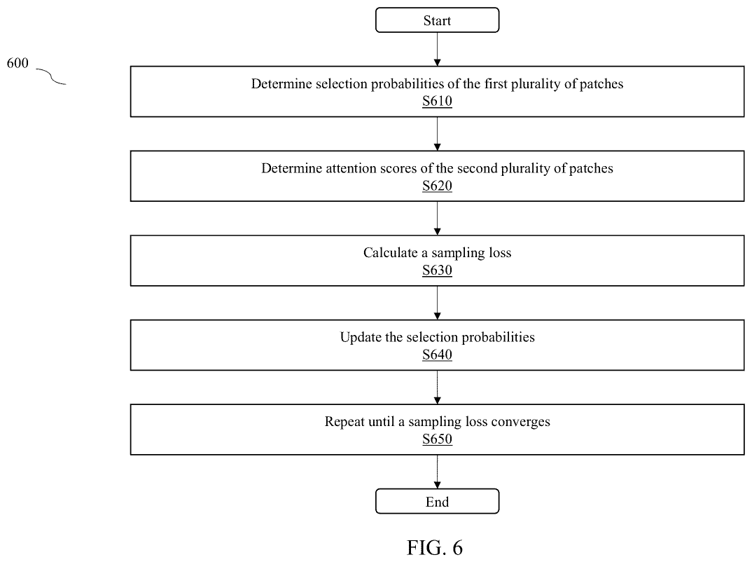

Descriptions of several example operations which may be performed by the processor 120 of the CD system 100 for determining a classification are provided below with reference to FIG. 5 to FIG. 6.

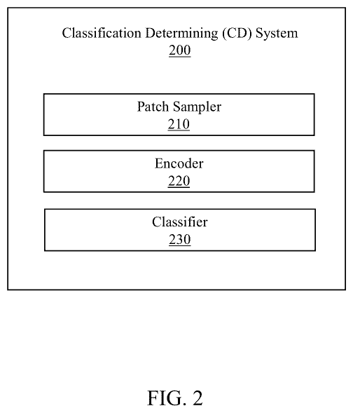

FIG. 2 illustrates a block diagram of example components in a CD system 200, according to one or more embodiments. The CD system 200 may correspond to the CD system 100 in FIG. 1, thus the features associated with the CD system 100 and the CD system 200 may be similarly applicable to each other, unless being explicitly described otherwise.

As illustrated in FIG. 2, the CD system 200 may include at least one patch sampler 210, at least one encoder 220, and at least one classifier 230, although it can be understood that the CD system 200 may include more or less components than as illustrated in FIG. 2, and/or may be arranged in a manner different from as illustrated in FIG. 2, without departing from the scope of the present disclosure.

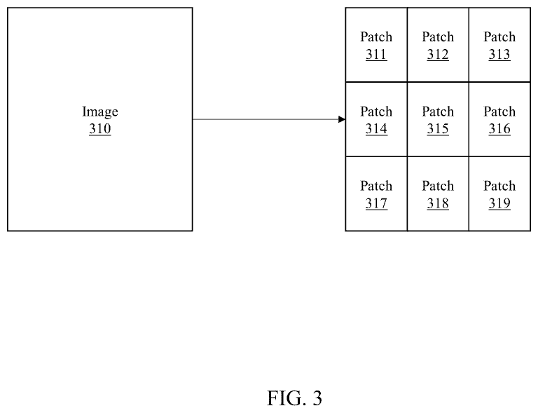

According to embodiments, the CD system 200 may be configured to receive an image or a plurality of images (e.g., frames in a video), and process the received image to obtain a plurality of patches (i.e., a first plurality of patches) comprised in the image. Referring now to FIG. 3, a plurality of patches are included in an image. It may be understood that an image may be processed to obtain a plurality of patches, which may correspond to a plurality of portions of the image. For example, as shown in FIG. 3, image 310 may be processed to obtain patch 311 corresponding to the top left portion of the image 310, patch 312 corresponding to the top middle portion of the image 310, patch 313 corresponding to the top right portion of the image 310, patch 314 corresponding to the middle left portion of the image 310, patch 315 corresponding to the center portion of the image 310, patch 316 corresponding to the middle right portion of the image 310, patch 317 corresponding to the bottom left portion of the image 310, patch 318 corresponding to the bottom middle portion of the image 310, and patch 319 corresponding to the bottom right portion of the image 310. It may be understood that the number of patches may be any number, and may correspond to any portions of the image.

According to embodiments, the patch sampler 210 may be configured to determine selection probabilities of the obtained first plurality of patches, and select a plurality of patches (i.e., a second plurality of patches) from among the obtained first plurality of patches based on the determined selection probabilities. The patch sampler 210 may include one or more components for determining the selection probabilities and for selecting the second plurality of patches. For example, the patch sampler 210 may include a one-layer transformer followed by a linear layer and softmax. As another example, the patch sampler 210 may include a multi-head attention (MHA) sub-layer and a fully connected feedforward network sub-layer followed by a linear layer and softmax. According to embodiments, the patch sampler 210 may also include a policy network and a multinomial sampling step. It may be understood that the patch sampler 210 may include more or less components and may have a different structure without departing from the scope of the present disclosure.

According to embodiments, the patch sampler 210 may be a machine learning model that is trained based on a sampling loss for backpropagation. The sampling loss may be computed using a loss function through gradient descent, and may indicate a difference between the selection probabilities and attention scores of the image obtained via the encoder 220. In particular, the sampling loss may indicate a difference between a distribution of the selection probabilities and a distribution of the attention scores, where the patch sampler 210 may be trained to minimize or converge the sampling loss (i.e., to make the distribution of the selection probabilities and the distribution of the attention scores aligned). In other words, the patch sampler 210 may be trained to determine the selection probabilities of the first plurality of patches in a manner that aligns the selection probabilities with the attention scores of the corresponding patches. For example, if a patch has a high attention score, the patch sampler 210 may be trained to give said patch a high selection probability, and if a patch has a low attention score, the patch sampler 210 may be trained to give said patch a low selection probability. According to embodiments, the loss function used to compute the sampling loss may comprise a REINFORCE algorithm, a Mean Squared Error (MSE) loss, a Kullback-Leibler (KL) Divergence loss, and the like. For example, the loss function may comprise the REINFORCE algorithm having the selection probabilities as the action and the attention scores as the reward, such that, for a patch with a high/low attention score, the selection probability for that patch shall be changed/updated to match such high/low attention score. It may be understood that the labelling of the sampling loss is used to describe the loss value used to train the patch sampler 210, and is not used to limit the loss value to any specific algorithm. According to embodiments, the patch sampler 210 may be differentiable and lightweight to allow for backpropagation via the loss function while achieving high performance.

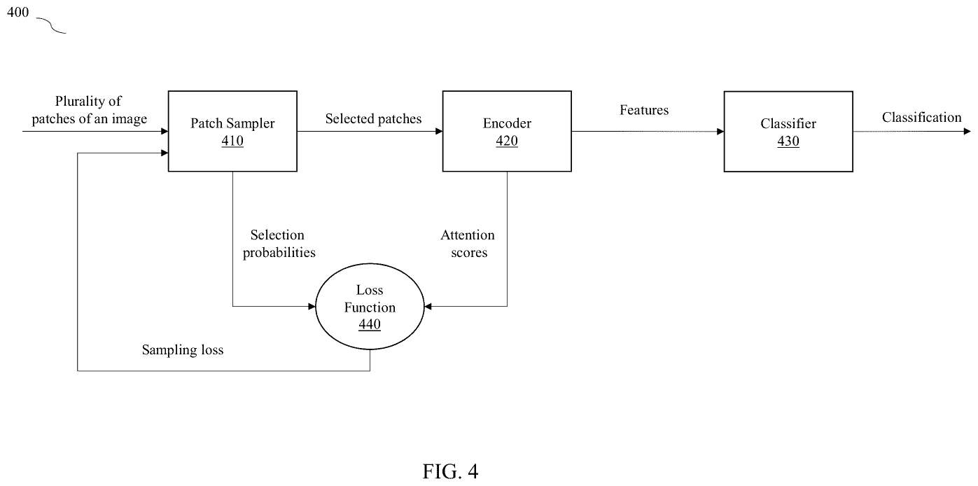

Descriptions of several example operations which may be performed by the patch sampler 210 are provided below with reference to FIG. 4 to FIG. 6.

According to embodiments, the encoder 220 may be configured to process the selected second plurality of patches in order to extract (or determine) one or more features of the selected second plurality of patches, and compute the attention scores of the second plurality of patches. It may be understood that the attention scores (which are computed based on attention weights) indicate an importance of a corresponding patch. For example, a patch which clearly indicates an important element of an image (e.g., a person, an action, an animal, and the like) may receive a high attention score, while a patch which does not indicate any important element of an image (e.g., empty sky, ground, dark/undiscernible areas, and the like) may receive a low attention score. The encoder 220 may include one or more components for determining the one or more features and the attention scores. For example, the encoder 220 may comprise a Vision Transformers (ViTs) encoder including a number of transformer layers, as well as a neural network model. The neural network model may include a multilayer perceptron (MLP) neural network model, however embodiments are not limited thereto.

According to embodiments, the encoder 220 may be trained based on a cross entropy loss. The cross entropy loss may be computed using a loss function, and may indicate a difference between a ground-truth label and the resulting classification of the image (obtained via the classifier 230 based on the features extracted by the encoder 220). The ground-truth label may refer to a target label which the result of the classification should correspond to in order to produce an accurate classification. The encoder 220 may be trained to minimize or converge the cross entropy loss. For example, if the ground-truth label is a “human”, the encoder 220 may be trained to give the patches showing human high attention scores and to give patches with elements other than human low attention scores, such that the patches showing human(s) contribute more significantly to the resulting classification of the image. Accordingly, the resulting classification of the image may be “human”, where the cross entropy loss is minimized.

According to embodiments, the encoder 220 may be pre-trained and then be frozen while the patch sampler 210 is being trained, such that the selection probabilities are trained/changed while the attention scores remain static for the same input. According to embodiments, the encoder 220 may be trained at the same time as the patch sampler 210, such that both the selection probabilities and the attention scores are trained/changed alongside each other. According to embodiments, the encoder 220 may be pre-trained and then be further trained at the same time as the patch sampler 210, such that the encoder 220 be fined tuned with the patch sampler 210.

Descriptions of several example operations which may be performed by the encoder 220 are provided below with reference to FIG. 4 to FIG. 6.

According to embodiments, the classifier 230 may be configured to determine a classification of the image. In particular, the classifier 230 may process features from the second plurality of patches, in order to determine the classification of the image. The classification may include, for example, a bird, a ball, a car, and the like that represents the image. According to embodiments, the classifier 230 may comprise a classification head.

Descriptions of several example operations which may be performed by the classifier 230 are provided below with reference to FIG. 4 to FIG. 5.

As indicated above, the CD system 200 may include more or less components than as illustrated in FIG. 2. For example, the CD system 200 may include additional components, such as one or more patch embedding layers and the like for obtaining patch embeddings to be provided to the patch sampler 210.

FIG. 4 illustrates an example flow for determining a classification of an image, according to one or more embodiments.

As illustrated in FIG. 4, the flow for determining a classification of an image in the present disclosure may involve at least one patch sampler 410, at least one encoder 420, at least one classifier 430, and at least one loss function 440. The patch sampler 410, encoder 420, classifier 430, and loss function 440 may respectively correspond to the patch sampler 210, encoder 220, classifier 230, and loss function described above in relation to FIG. 2, thus the features associated with the above elements may be similarly applicable to each other, unless explicitly described otherwise.

The patch sampler 410 may first receive a plurality of patches of an image (i.e., first plurality of patches). In particular, according to embodiments, the input to the patch sampler 410 (e.g., the policy network) may be a set of tokens (i.e., first plurality of patches) that are represented by X∈R^{N×d}, where N represents the number of tokens (i.e., the number of the first plurality of patches) and d represents the embedding dimensions. Further, the number of tokens may be defined according to a following equation:

$$N = \frac{T}{t} \times \frac{H}{h} \times \frac{W}{w}$$

Where (T, H, W) and (t, h, w) represent temporal frames, height, and width respectively. According to example embodiments, the above equation including T/t may be used for video inputs. According to example embodiments, T/t in the above equation may be replaced with 1 for image inputs. It may be understood that prior to passing the tokens to the patch sampler 410, the fixed periodic positional encoding may be performed in order to allow the patch sampler 410 to consider positional information when modelling the distribution of the selection probabilities.

The patch sampler 410 may then determine the selection probabilities of the first plurality of patches, where the selection probabilities may be represented by P∈R^{N}, where N represents the number of tokens (i.e., the number of the first plurality of patches). Further, the patch sampler 410 may select the second plurality of patches from among the obtained first plurality of patches based on the determined selection probabilities. According to embodiments, the second plurality of patches may be selected based on the determined selection probabilities according to a probability distribution. The probability distribution may comprise, for example, a multinomial distribution. In particular, using the selection probabilities, the patch sampler 410 may perform multinomial sampling to select a number of patch indices represented by Iᵥ without replacement. The patch indices may indicate which patch from among the first plurality of patches to select. The number of the selected patch indices (i.e., the number of the selected second plurality of patches) may be represented by K, which may be less than N. As such, it may be understood that the number of the second plurality of patches may be less than the number of the first plurality of patches. According to embodiments, the number of patches to be selected may be predefined by a user. Subsequently, the patch sampler 410 may apply indexing using the indices Iᵥ to retrieve the tokens represented by Xᵥ∈R^{K×d}, and transmit such tokens to the encoder 420. It may be understood that, since multinomial sampling and indexing are non-differentiable operations, sampling loss may be used to update the selection probabilities as described below.

Accordingly, the number of patches to be processed by the encoder 420 and the classifier 430 in order to determine the classification of the image can be reduced (i.e., from N to K), which reduces computational resource requirements and improves efficiency and speed of inference.

The encoder 420 may then process the selected second plurality of patches in order to obtain features and attention scores of the second plurality of patches. According to embodiments, the attention scores may be computed based on attention weights, where each of the attention weights indicates an importance of a corresponding patch. In the subsequent equations, the head dimension is omitted in MHA for simplicity.

According to embodiments, the encoder 420 may first compute attention weights for the second plurality of patches according to a following equations:

$$Attention ( Q , K , V ) = AV$$

$$A = softmax ( \frac{Q {K}^{T}}{\sqrt{{d}_{k}}} )$$

Where A represents an attention weight, Q represents a query, K represents a key, V represents value matrices, dₖ represents a dimension of the keys, and T represents the transpose operation. It may be understood that the above parameters may be obtained from the encoder in the manner as known in the art. Thus, descriptions associated therein are omitted.

Once the attention weights are obtained, the encoder 420 may then compute the attention scores for the second plurality of patches. In particular, as indicated above, the encoder 420 may include a number of transformer layers. In this regard, for each specific patch, the encoder 420 may be configured to compute a plurality of individual attention scores from a plurality of transformer layers. The plurality of transformer layers may comprise a last n layers of the encoder 420, where the encoder 420 may be configured to compute n individual attention scores from the last n layers of the encoder 420. For example, returning to FIG. 3, if the encoder 420 has 12 transformer layers, the encoder 420 may be configured to compute 4 individual attention scores from the last 4 layers (i.e., the 8^{th} to the 12^{th} layer) for patch 311, compute 4 individual attention scores from the last 4 layers for patch 312, and the like. This is because the attention scores (which indicate the importance of the corresponding patches) will get more accurate in the later layers of the encoder. The attention scores may be represented as Rₐₜₜₙ∈R^{K}, where K represents the number of selected patches (i.e., the number of the second plurality of patches).

According to embodiments, a classify token (CLS) may exist and may be used as an output of the encoder 420, where A∈R^{(K+1)×(K+1)}. Accordingly, the plurality of individual attention scores may be computed according to a following equation:

$${R}_{attn j}^{( i )} = {A}_{1 , j + 1}^{( i )} \times ‖ {V}_{j + 1}^{( i )} ‖$$

Where R_{attn j}⁽ⁱ⁾ represents an attention score of patch j from transformer layer i, K represents a number of selected patches, A_{1,j+1}⁽ⁱ⁾ represents an attention weight of patch j from transformer layer i, and Vⱼ₊₁⁽ⁱ⁾ represents a value matrices of patch j from transformer layer i. Here, it may be understood that, since A_{1,1:K+1} contains the attention weights of the output token, A_{1,j+1} represents the importance of patch j to the output.

According to embodiments, a classify token (CLS) may not exist and an output of the encoder 420 may be the global pool (average) of all tokens, where A∈R^{(K)×(K)}. Accordingly, the plurality of individual attention scores may be computed according to a following equation:

$${R}_{attn j}^{( i )} = \frac{1}{K} {\sum }_{k = 1}^{K} {A}_{k , j}^{( i )} \times ‖ {V}_{j}^{( i )} ‖$$

Where R_{attn j}⁽ⁱ⁾ represents an attention score of patch j from transformer layer i, K represents a number of selected patches, A_{k,j}⁽ⁱ⁾ represents an attention weight between patch k and patch j from transformer layer i, and Vⱼ⁽ⁱ⁾ represents a value matrices of patch j from transformer layer i. Here, it may be understood that, since global pooling is done on all tokens,

$$\frac{1}{K} {\sum }_{k = 1}^{K} {A}_{k , j}$$

represents the importance of patch j to the output.

According to embodiments, once the plurality of individual attention scores from a plurality of transformer layers are computed, the encoder 420 may be configured to aggregate the plurality of individual attention scores to obtain the attention score for the specific patch. According to embodiments, the plurality of individual attention scores may be aggregated by summing the n individual attention scores to obtain the attention score for the specific patch according to a following equation:

$${R}_{a t t n} = {\sum }_{i = {l}_{m}}^{{l}_{n}} {R}_{attn}^{( i )}$$

Where Rₐₜₜₙ represents an attention score of the specific patch, Iₘ to Iᵥ represent the last n transformer layers, and Rₐₜₜₙ⁽ⁱ⁾ represents an attention score of the specific patch from transformer layer i. According to embodiments, the attention scores may be summed up over all heads in order to account for the fact that different heads may attend to different regions of importance. Accordingly, the attention scores may be used as a supervision signal for training the patch sampler 410, such that the CD system can perform self-attention.

The value of n, representing the number of last layers in the encoder 420 may vary and may be any number. For example, n may be a natural number between 1 and the total number of transformer blocks in the encoder 420. According to embodiments, setting n to 4 (i.e., last 4 layers of the encoder 420) is preferred since the last 4 layers allow for the attention scores to be computed most accurately and achieve best performance in comparison to other layers. However, setting n to 1, 3, 5, or 6 also results in good performance.

The classifier 430 may then process the features of the second plurality of patches to determine which patch should contribute more or less to the classification of the image, and determine the classification of the image based on the features of the second plurality of patches. Accordingly, accurate classification of the image may be determined with reduced number of patches, which improves efficiency. Further, since the attention scores are obtained from the model that is being subjected to patch dropping instead of some other separate model, no extra computation is incurred.

In this regard, once the selection probabilities and the attention scores are obtained, the patch sampler 410 may be trained based on the above parameters in order to better select the second plurality of patches. In particular, as shown in FIG. 4, the patch sampler 410 may be trained based on a sampling loss computed using a loss function 440 based on the selection probabilities and attention scores. It may be understood that, since the attention score indicates an importance of a corresponding patch, the attention score may be used in order to train the patch sampler 410 to give a higher/lower selection probability to the corresponding patch. For example, the patch sampler 410 may be trained in order to give a patch with a high attention score (i.e., a patch that shows an important element of an image) high selection probability, such that said patch is more likely to be selected and used again for determining the classification of the image. On the other hand, the patch sampler 410 may be trained in order to give a patch with a low attention score (i.e., a patch that does not show any an important element of an image) low selection probability, such that said patch is less likely to be selected and used again for determining the classification of the image thereby allowing for other more important patches to be selected and used for determining the classification of the image. According to embodiments, the loss function may be defined as:

$${L}_{P S} = - {\sum }_{j = 1}^{K} log ( {P}_{( {I}_{v} ) j} ) \cdot detach ( {( {R}_{a t t n} )}_{j} )$$

Where (Rₐₜₜₙ)ⱼ represents an attention score of patch j, K represents a number of selected patches, Iᵥ represents the indices of the selected patches, and P represents the selection probabilities. Here, it may be understood that the patch sampler 410 is trained with the selection probabilities as actions and the attention scorers as rewards, where the goal is to maximize the expected attention scores. Further, the logarithm of the probabilities may be used instead of the probabilities themselves to avoid prevision errors, where the attention scores may be detached from the computation graph to prevent the loss from affecting the weights of the encoder 420. Further, it may be understood that the loss function may result in the patch sampler 410 (e.g., policy network) aligning the distribution of the selection probabilities with the distribution of the attention scores, since the selection probabilities of the patches with the highest attention scores will be maximized. According to embodiments, the loss function may be interpreted as a cross entropy between the selection probabilities and the attention scores.

Accordingly, performance and accuracy for determining the classification of the image may be improved, while also improving the computational resource requirements, efficiency and speed of inference due to fewer patches being selected.

It may be understood that, while the present disclosure discusses the determination of a classification of an image, the same processes may be applied for the determination of a classification of a video. In particular, for a classification of an image, the input patches may have at least two dimensions (width and height). In this regard, for a classification of a video, the input patches may instead have at least three dimensions (time, width, and height), where the same processes may be applied to the 3D patches (t, w, h) of the video. In view of the above, it may be understood that the term “image” as used herein, may encompass a broad range of visual representations, extending from static images to dynamic images like videos including a sequence of frames. Further, for image understanding tasks, the present disclosure may be applied to image classification, breed classification, scene classification, and the like. Similarly, for video understanding tasks, the present disclosure may be applied to video action recognition, multimodal video retrieval, and the like. Further, it may be understood that the above process involving the selection of the patches may be performed during training or inference.

Below, several example operations performable by the CD system of the present disclosure are described with reference to FIG. 5 to FIG. 6.

FIG. 5 illustrates a flow diagram of an example method 500 for determining a classification of an image, according to one or more embodiments. One or more operations in method 500 may be performed by at least one processor (e.g., processor 120) of the CD system.

As illustrated in FIG. 5, at operation S510, the at least one processor may be configured to obtain a first plurality of patches of an image. According to embodiments, the first plurality of patches may be obtained by receiving an image, and dividing the image into the first plurality of patches. The first plurality of patches may correspond to a plurality of portions of the image. According to embodiments, the first plurality of patches may comprise and/or be associated with patch embeddings, positional encodings, and the like of the image. The method then proceeds to operation S520.

At operation S520, the at least one processor may be configured to determine selection probabilities of the first plurality of patches. It may be understood that a selection probability of a patch may indicate a probability for said patch to be selected during operation S530. The method then proceeds to operation S530.

At operation S530, the at least one processor may be configured to select a second plurality of patches from among the first plurality of patches. According to embodiments, the second plurality of patches may be selected from among the first plurality of patches based on the selection probabilities. For example, the second plurality of patches may be selected from among the first plurality of patches based on the selection probabilities according to a probability distribution, such as a multinomial distribution and the like. According to embodiments, the second plurality of patches may be selected by the patch sampler model.

According to embodiments, the selection probabilities of the first plurality of patches may be determined by a patch sampler model that is trained based on a sampling loss. According to embodiments, the sampling loss may indicate a difference between the selection probabilities and attention scores of the image obtained via an encoder. According to embodiments, the sampling loss may indicate a difference between a distribution of the selection probabilities and a distribution of the attention scores of the image.

According to embodiments, the patch sampler model may be trained to minimize or converge the sampling loss. For example, the patch sampler model may be trained to minimize or converge the sampling loss, such that the sampling loss between the distribution of the selection probabilities of the second plurality of patches and the distribution of the attention scores of the second plurality of patches is reduced to a predetermined threshold or converges. According to embodiments, the predetermined threshold and the convergence may be predetermined by a user.

According to embodiments, the patch sampler model may be trained based on the sampling loss using a loss function. According to embodiments, the loss function may include a reinforce algorithm based on the selection probabilities as an action and the attention scores as a reward. According to embodiments, the loss function may comprise a Mean Squared Error (MSE) loss or a Kullback-Leibler (KL) Divergence loss.

In particular, according to example embodiments, once the second plurality of patches are selected, the at least one processor may be configured compute attention scores of the second plurality of patches. Once the attention scores of the second plurality of patches are computed, the patch sampler model may be trained to minimize or converge the sampling loss (i.e., minimize a difference between a distribution of the selection probabilities of the second plurality of patches and a distribution of the attention scores of the second plurality of patches).

Several example operations performable by the CD system of the present disclosure for determining the selection probabilities are described below with reference to FIG. 6.

According to embodiments, the attention scores of the second plurality of patches may be computed based on attention weights of the second plurality of patches. Each of the attention weights may indicate an importance of a corresponding patch of the second plurality of patches. According to embodiments, the attention scores of the second plurality of patches may be computed by an encoder.

According to embodiments, each of the attention scores may be computed by, for a specific patch among the second plurality of patches, computing a plurality of individual attention scores from a plurality of transformer layers of the encoder. According to embodiments, the plurality of transformer layers may comprise a last n layers of the encoder. According to embodiments, n may be a natural number between 1 and the total number of transformer blocks in the encoder. For example, the plurality of transformer layers may comprise a last 4 layers of the encoder. As such, the plurality of individual attention scores may be computed by computing n individual attention scores from the last n layers of the encoder. For example, the plurality of individual attention scores may be computed by computing a first individual attention score from the last layer of the encoder, computing a second individual attention score from the second last layer of the encoder, computing a third individual attention score from the third last layer of the encoder, and computing a fourth individual attention score from the fourth last layer of the encoder.

According to embodiments, each of the attention scores may be computed further by aggregating the plurality of individual attention scores to obtain the attention score for the specific patch. According to embodiments, the plurality of individual attention scores may be aggregated by summing the n individual attention scores to obtain the attention score for the specific patch. For example, the individual attention scores may be aggregated by summing the first, second, third, and fourth individual attention scores together to obtain the attention score for the specific patch. The method then proceeds to operation S540.

At operation S540, the at least one processor may be configured to determine a classification of the image. According to embodiment, the classification of the image may be determined by processing the second plurality of patches through the encoder. According to embodiments, the classification of the image may be determined based on the second plurality of patches. According to embodiments, the classification of the image may be determined based on features of the second plurality of patches.

According to embodiments, the encoder may be pre-trained. According to embodiments, the encoder may be trained based on a cross entropy loss at the same time as the patch sampler model. The cross entropy loss may be computed using a loss function, and may indicate a difference between the ground-truth label and the classification of the image obtained via a classifier.

Upon performing operation S540, the method 500 may be ended or be terminated. In some embodiments, method 500 may return to operation S510, such that the at least one processor may be configured to repeatedly perform, for at least a predetermined amount of time, the obtaining the first plurality of patches (at operation S510), the determining the selection probabilities (at operation S520), the selecting the second plurality of patches (at operation S530), and the determining the classification (at operation S540).

For example, the at least one processor may repeatedly perform the obtaining the first plurality of patches (at operation S510), the determining the selection probabilities (at operation S520), the selecting the second plurality of patches (at operation S530), and the determining the classification (at operation S540) for each of a plurality of images stored in the memory of the system, for each of a plurality of frames (images) of a video stored in the memory of the system, and/or for each of a plurality of videos stored in the memory of the system.

FIG. 6 illustrates a flow diagram of an example method 600 for determining the selection probabilities, according to one or more embodiments. One or more operations of method 600 may be part of operations S520 in method 500, and may be performed by at least one processor (e.g., processor 120) of the CD system.

As illustrated in FIG. 6, at operation S610, the at least one processor may be configured to determine the selection probabilities of the first plurality of patches. The method then proceeds to operation S620.

At operation S620, the at least one processor may be configured to determine the attention scores of the second plurality of patches. It may be understood that, as described above in relation to method 500, the second plurality of patches may be selected from among the first plurality of patches. In this regard, the encoder may be configured to determine the attention scores of the selected second plurality of patches. The method then proceeds to operation S630.

At operation S630, the at least one processor may be configured to calculate the sampling loss based on the selection probabilities of the second plurality of patches and the attention scores of the second plurality of patches. It may be understood that, as described above in relation to method 500, the sampling loss may indicate a difference between the selection probabilities and attention scores. Accordingly, the sampling loss may also indicate a difference between the selection probabilities of the second plurality of patches and the attention scores of the second plurality of patches. The method then proceeds to operation S640.

At operation S640, the at least one processor may be configured to update the selection probabilities of the first plurality of patches based on the sampling loss. According to embodiments, the at least one processor may be configured to update the selection probabilities of the first plurality of patches based on the sampling loss, such that the sampling loss is minimized. According to embodiments, the at least one processor may be configured to update the selection probabilities of the first plurality of patches based on the sampling loss, such that the selection probabilities of the second plurality of patches align with the attention scores of the second plurality of patches.

For example, returning to FIG. 3, if patch 315 and patch 318 are selected (i.e., the second plurality of patches comprise patch 315 and patch 318), the at least one processor may be configured to determine the attention scores of patch 315 and patch 318, where the attention score of patch 315 is high and the attention score of patch 318 is low. In this regard, the at least one processor may be configured to calculate the sampling loss based on the selection probabilities of patch 315 and patch 318 and the attention scores of patch 315 and patch 318, and then update the selection probabilities of patches 311 to 319 based on the sampling loss, such that the selection probabilities of patch 315 and patch 318 align with the attention scores of patch 315 and patch 318, respectively. For example, the selection probability of patch 315 may be increased to align with the high attention score of patch 315, such that patch 315 is more likely to be selected again. On the other hand, the selection probability of patch 318 may be decreased to align with the low attention score of patch 318, such that patch 318 is less likely to be selected again. The selection probabilities for patches 311-314, 316-317, and 319 may be updated in response to the changes to the selection probabilities of patch 315 and patch 318. The method then proceeds to operation S650.

At operation S650, the at least one processor may be configured to repeat operations S610, S620, S630, and S640 until the sampling loss between a distribution of the selection probabilities of the second plurality of patches and a distribution of attention scores of the second plurality of patches is reduced to a predetermined threshold or converges. It may be understood that, as operations S610, S620, S630, and S640 are repeated, different patches of the first plurality of patches may be selected as the second plurality of patches, where their respective selection probabilities may be updated based on the sampling loss such that their selection probabilities align with their attention scores. As such, operations S610, S620, S630, and S640 may be repeated at least until the sampling loss between the distribution of the selection probabilities of the second plurality of patches (selected patches) and a distribution of attention scores of the second plurality of patches (selected patches) is reduced to a predetermined threshold or converges.

The foregoing disclosure provides illustration and description, but is not intended to be exhaustive or to limit the implementations to the precise form disclosed. Modifications and variations are possible in light of the above disclosure or may be acquired from practice of the implementations.

Some embodiments may relate to a system, a method, and/or a computer readable medium at any possible technical detail level of integration. Further, one or more of the above components described above may be implemented as instructions stored on a computer readable medium and executable by at least one processor (and/or may include at least one processor). The computer readable medium may include a computer-readable non-transitory storage medium (or media) having computer readable program instructions thereon for causing a processor to carry out operations.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program code/instructions for carrying out operations may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects or operations.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer readable media according to various embodiments. In this regard, each block in the flowchart or block diagrams may represent a microservice(s) module, segment, or portion of instructions, which comprises one or more executable instructions for implementing the specified logical function(s). The method, computer system, and computer readable medium may include additional blocks, fewer blocks, different blocks, or differently arranged blocks than those depicted in the Figures. In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code-it being understood that software and hardware may be designed to implement the systems and/or methods based on the description herein.

It can be understood that numerous modifications and variations of the present disclosure are possible in light of the above teachings. It will be apparent that within the scope of the appended clauses, the present disclosures may be practiced otherwise than as specifically described herein.

What is claimed is:

1. An image processing method comprising:
determining, by a patch sampler model, selection probabilities of a first plurality of patches included in an image;
selecting, by the patch sampler model, a second plurality of patches from among the first plurality of patches of the image based on the selection probabilities; and
determining a classification of the image by processing the second plurality of patches through an encoder;
wherein the patch sampler model is trained based on a sampling loss which indicates a difference between the selection probabilities and attention scores of the image obtained via the encoder.

2. The image processing method according to claim 1, wherein the attention scores are computed based on attention weights of the second plurality of patches, and wherein each of the attention weights indicates an importance of a corresponding patch of the second plurality of patches.

3. The image processing method of claim 1, wherein each of the attention scores is computed by:
for a specific patch among the second plurality of patches, computing a plurality of individual attention scores from a plurality of transformer layers of the encoder; and
aggregating the plurality of individual attention scores to obtain the attention score for the specific patch.

4. The image processing method of claim 3, wherein:
the plurality of transformer layers comprises a last n layers of the encoder, wherein n is a natural number between 1 and a total number of transformer blocks in the encoder; and
the computing the plurality of individual attention scores comprises:
computing n individual attention scores from the last n layers of the encoder; and
summing the n individual attention scores to obtain the attention score for the specific patch.

5. The image processing method of claim 3, wherein the plurality of individual attention scores are computed according to a following equation:
$${R}_{attn j}^{( i )} = \frac{1}{K} {\sum }_{k = 1}^{K} {A}_{k , j}^{( i )} \times ‖ {V}_{j}^{( i )} ‖ ,$$
wherein R_{attn j}⁽ⁱ⁾ represents an attention score of patch j from transformer layer i, K represents a number of selected patches, A_{k,j}⁽ⁱ⁾ represents an attention weight between patch k and patch j from transformer layer i, and Vⱼ⁽ⁱ⁾ represents a value matrices of patch j from transformer layer i.

6. The image processing method according to claim 1, wherein the determining the selection probabilities comprises:
determining the selection probabilities of the first plurality of patches;
determining attention scores of the second plurality of patches;
calculating the sampling loss based on the selection probabilities of the second plurality of patches and the attention scores of the second plurality of patches;
updating the selection probabilities of the first plurality of patches based on the sampling loss; and
repeating the determining the selection probabilities, the determining the attention scores, the calculating the sampling loss, and the updating the selection probabilities until the sampling loss between a distribution of the selection probabilities of the second plurality of patches and a distribution of attention scores of the second plurality of patches is reduced to a predetermined threshold or converges.

7. The image processing method according to claim 1, wherein the patch sampler model is trained using a reinforce algorithm based on the selection probabilities as an action and the attention scores as a reward.

8. The image processing method according to claim 1, wherein the patch sampler model is trained using a Mean Squared Error (MSE) loss or a Kullback-Leibler (KL) Divergence loss.

9. The image processing method according to claim 1, wherein the encoder is trained based on a cross entropy loss.

10. An image processing system comprising:
a memory storage storing computer-executable instructions; and
at least one processor communicatively coupled to the memory storage, wherein the at least one processor is configured to execute the instructions to:
determine, by a patch sampler model, selection probabilities of a first plurality of patches included in an image;
select, by the patch sampler model, a second plurality of patches from among the first plurality of patches of the image based on the selection probabilities; and
determine a classification of the image by processing the second plurality of patches through an encoder;
wherein the patch sampler model is trained based on a sampling loss which indicates a difference between the selection probabilities and attention scores of the image obtained via the encoder.

11. The image processing system according to claim 10, wherein the attention scores are computed based on attention weights of the second plurality of patches, and wherein each of the attention weights indicates an importance of a corresponding patch of the second plurality of patches.

12. The image processing system of claim 10, wherein each of the attention scores is computed by:
for a specific patch among the second plurality of patches, computing a plurality of individual attention scores from a plurality of transformer layers of the encoder; and
aggregating the plurality of individual attention scores to obtain the attention score for the specific patch.

13. The image processing system of claim 12, wherein:
the plurality of transformer layers comprises a last n layers of the encoder, wherein n is a natural number between 1 and a total number of transformer blocks in the encoder; and
the plurality of individual attention scores are computed by:
computing n individual attention scores from the last n layers of the encoder; and
summing the n individual attention scores to obtain the attention score for the specific patch.

14. The image processing system of claim 12, wherein the plurality of individual attention scores are computed according to a following equation:
$${R}_{attn j}^{( i )} = \frac{1}{K} {\sum }_{k = 1}^{K} {A}_{k , j}^{( i )} \times ‖ {V}_{j}^{( i )} ‖ ,$$
wherein R_{attn j}⁽ⁱ⁾ represents an attention score of patch j from transformer layer i, K represents a number of selected patches, A_{k,j}⁽ⁱ⁾ represents an attention weight between patch k and patch j from transformer layer i, and Vⱼ⁽ⁱ⁾ represents a value matrices of patch j from transformer layer i.

15. The image processing system according to claim 10, wherein the at least one processor is configured to execute the instructions to determine the selection probabilities by:
determining the selection probabilities of the first plurality of patches;
determining attention scores of the second plurality of patches;
calculating the sampling loss based on the selection probabilities of the second plurality of patches and the attention scores of the second plurality of patches;
updating the selection probabilities of the first plurality of patches based on the sampling loss; and
repeating the determining the selection probabilities, the determining the attention scores, the calculating the sampling loss, and the updating the selection probabilities until the sampling loss between a distribution of the selection probabilities of the second plurality of patches and a distribution of attention scores of the second plurality of patches is reduced to a predetermined threshold or converges.

16. The image processing system according to claim 10, wherein the patch sampler model is trained using a reinforce algorithm based on the selection probabilities as an action and the attention scores as a reward.

17. The image processing system according to claim 10, wherein the patch sampler model is trained using a Mean Squared Error (MSE) loss or a Kullback-Leibler (KL) Divergence loss.

18. The image processing system according to claim 10, wherein the encoder is trained based on a cross entropy loss.

19. A non-transitory computer-readable recording medium having recorded thereon instructions executable by at least one processor to cause the at least one processor to perform a method comprising:
determining, by a patch sampler model, selection probabilities of a first plurality of patches included in an image;
selecting, by the patch sampler model, a second plurality of patches from among the first plurality of patches of the image based on the selection probabilities; and
determining a classification of the image by processing the second plurality of patches through an encoder;
wherein the patch sampler model is trained based on a sampling loss which indicates a difference between the selection probabilities and attention scores of the image obtained via the encoder.

20. The non-transitory computer-readable recording medium according to claim 19, wherein the attention scores are computed based on attention weights of the second plurality of patches, and wherein each of the attention weights indicates an importance of a corresponding patch of the second plurality of patches.
